(19) United States
(12) Patent Application Publication
(10) Pub. No.: US 2005/0152028 A1
(43) Pub. Date: Jul. 14, 2005

(54) Illumination device for a microscope

(75) Inventor: Reiner Mitzkus, Goettingen (DE)

Correspondence Address: REED SMITH LLP, 599 Lexington Avenue, New York, NY, 10022-7650, US

(73) Assignee: Carl Zeiss Jena GmbH

(21) Appl. No.: 11/013,987

(22) Filed: Dec. 16, 2004

(30) Foreign Application Priority Data
Dec. 16, 2003 (DE) 203 19 495.0

(51) Int. Cl. G02B 21/06

(52) U.S. Cl. 359/385; 359/390

(57) ABSTRACT

An illumination device for a microscope comprising an additional illumination source that is arranged at the microscope or at microscope components in such a way that the sample space is illuminated over a large surface area and/or pointwise.

### CROSS-REFERENCE TO RELATED APPLICATION

This application claims priority of German Application No. 203 19 495.0 filed Dec. 16, 2003, the complete disclosure of which is hereby incorporated by reference.

### BACKGROUND OF THE INVENTION

a) Field of the Invention

The present invention is directed to an illumination device for a microscope by which a sample to be examined is illuminated over a large surface area in order to observe it in its entirety and to orient it in a corresponding manner.

b) Description of the Related Art

The microscopes known in the art usually only have the object illumination for incident and transmitted light required for display. In the simplest case, microscopes of this kind also have a first illumination source for incident light arranged at the microscope head and a second illumination source for transmitted light illumination arranged in the microscope base. As a rule, these illumination sources can be switched and/or regulated separately. However, the illumination source arranged at the microscope head causes the specimen under observation to be heated. In order to overcome this disadvantage, microscopes were developed which have only one illumination source that is usually located in the interior of the microscope and protects against the heat radiation of the light source.

A microscope having only one illumination device is described in DE 88 08 178 U1. This illumination device is arranged in the microscope base and illuminates the object stage selectively from below (transmitted light) or from above (incident light) by means of a deflecting system. In an advantageous embodiment, there are also different illumination sources for the different types of illumination which are separately switched and/or adjusted with respect to brightness. An additional condenser system is provided for the incident illumination which bundles the illumination light in an approximately parallel manner so that the illumination intensity does not depend upon the optical path length. The illumination is accordingly limited to illumination of the sample located on the object stage. An illumination of the entire sample space or of the space directly adjacent to the microscope is not possible. Picking up the sample and placing it securely on the object stage is made more difficult in that the microscope is generally used in a darkened room.

An illumination device for microscopes particularly for examining pathological specimens is proposed in DE 201 16 198 U1. In this solution, the light of the light source that is arranged in the microscope base is guided into the imaging plane by different deflecting elements for transmitted illumination or incident illumination. The illumination beam path is split in order to generate an additional beam path for external illumination of the specimen in addition to the microscope beam path. This makes it possible to directly observe the specimen on the object stage and to orient it with respect to position before actually viewing through the microscope. The required deflecting elements and the optical elements for splitting the illumination beam path considerably increase the expenditure on technical apparatus, especially since the external illumination is required only temporarily and a loss in intensity of the illumination for viewing through the microscope should be prevented.

### OBJECT AND SUMMARY OF THE INVENTION

It is the primary object of the present invention to develop a solution by which it is possible to pick up the sample to be examined and to position and orient it on the microscope stage, particularly in a darkened room.

This object is met, according to the invention, by an illumination device for a microscope comprising an additional illumination source that is arranged at the microscope or at microscope components in such a way that the sample space is illuminated over a large surface area and/or pointwise.

The proposed solution is usable in principle for all types of microscopes that are preferably used in darkened rooms.

This solution will be described more fully in the following with reference to embodiment examples.

### BRIEF DESCRIPTION OF THE DRAWING

In the drawing:

FIG. 1 shows a microscope and the preferred positions for the additional illumination unit.

### DESCRIPTION OF THE PREFERRED EMBODIMENTS

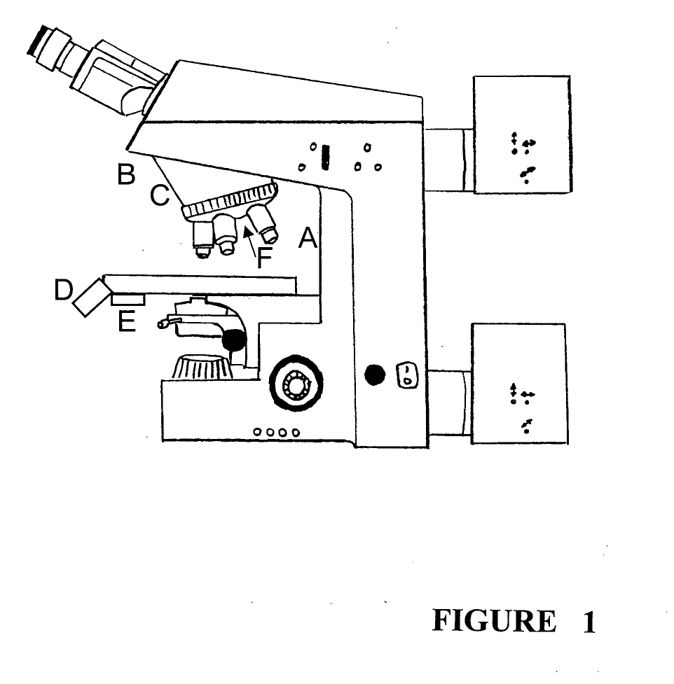

The proposed solution is directed to an illumination device for a microscope. An additional illumination source is arranged at the microscope in such a way that the sample space is illuminated over a large surface area and/or pointwise. FIG. 1 shows preferred positions A to F for the additional illumination source. The space above the object stage is considered to be the sample space. The additional illumination source can be switched and/or regulated with respect to its intensity separately, automatically or manually. The illumination source can preferably be active after the switching on process only for a period of time that can be selected beforehand.

A variety of light sources may be used as additional illumination source, e.g., light foils, light-emitting diodes, glow lamps, incandescent lamps, halogen lamps, fluorescent lamps, or gas discharge lamps of different wavelength. White light foils or light-emitting diode arrays emitting white light are preferably used for large-area, diffuse illumination. For point illumination, individual light-emitting diodes, halogen lamps, glow lamps, gas discharge lamps or fluorescent lamps are preferably used. The surfaces directly adjacent to the microscope are also advantageously illuminated by the illumination source.

With color illumination, a contrast-increasing effect can be achieved to improve the visibility of the specimen.

For this purpose, multicolored LEDs (blue, green red) whose mixed color results in white could be used. The mixed color achieving the best contrast for the specimen in question can be adjusted by suitable control, i.e., switching on, switching off or dimming the individual colored LEDs.

In another embodiment, optical elements can be arranged in front of the illumination source for shaping and guiding the emitted light. These optical elements can be, e.g., lenses, lens arrays, filters, mirrors, deflecting prisms, light-conducting fibers, or the like.

In a particularly advantageous embodiment, the illumination source is connected to a unit which switches on the illumination source for a defined period of time when the user's hand or an object approaches or touches the microscope stage.

With the proposed solution for illuminating the sample space of microscopes, it can also be ensured when the microscope is used in darkened rooms that the sample to be examined can be specifically picked up, positioned on the microscope stage and therefore also oriented faster. Accordingly, the sample can be viewed in its entirety in order to determine the section to be examined and position it in the beam path.

While the foregoing description and drawings represent the present invention, it will be obvious to those skilled in the art that various changes may be made therein without departing from the true spirit and scope of the present invention.

1. An illumination device for a microscope, comprising:
an additional illumination source that is arranged at the microscope or at microscope components in such a way that the sample space is illuminated over a large surface area and/or pointwise.

2. The illumination device according to claim 1, wherein the additional illumination source can be switched and/or regulated with respect to its intensity separately.

3. The illumination device according to claim 1, wherein the additional illumination source is optionally active permanently or for a period of time that can be selected beforehand after the switching on process.

4. The illumination device according to claim 1, wherein the additional illumination source likewise illuminates the surfaces directly adjacent to the microscope.

5. The illumination device according to claim 1, wherein the additional illumination source is connected to a unit which switches on the illumination source for a defined period of time when the user's hand or an object approaches or touches the microscope stage.

6. The illumination device according to claim 1, wherein the additional illumination source is monochrome for increasing contrast or comprises a mixed color of differently colored light sources.

7. The illumination device according to claim 6, wherein the hue of the additional illumination source can be adjusted when using differently colored light sources by regulating the brightness of the individual light sources.
